(19) United States
(12) Patent Application Publication
(10) Pub. No.: US 2024/0107983 A1
(43) Pub. Date: Apr. 4, 2024

(54) FOOT PROTECTION DEVICE FOR PET WITH FREELY ADJUSTABLE TIGHTNESS

(71) Applicant: NINGBO BOZHONG IMP.&EXP.CO.,LTD, Ningbo (CN)

(72) Inventor: Maozhou Liu, Fuzhou (CN)

(21) Appl. No.: 17/956,896

(22) Filed: Sep. 30, 2022

(51) Int. Cl. A01K 13/00

(52) U.S. Cl. CPC A01K 13/007

(57) ABSTRACT

A foot protection device for a pet with freely adjustable tightness comprises a foot wrap for a pet to wear, connecting belts connected with the foot wrap, an adjusting buckle, an inserting buckle and a plurality of pressing buckles, wherein the adjusting buckle is flat as a whole, a first hole and a second hole for passing through are provided on the adjusting buckle, and the inserting buckle is divided into a plug connector and a plug box which are mutually plugged, wherein the plug connector is provided with a first through hole for passing through, and the plug box is provided with a second hole for passing through. When it is worn by a pet, the front connecting belt passes through the first through hole and is locked by the pressing buckle, while the rear connecting belt passes through the second hole, the first hole and the second through hole in turn and is locked by the pressing buckle. The foot protection device for a pet is convenient to wear, and the foot wrap is connected with the connecting belts, so that the foot wrap is not easy to fall off; the free ends of the connecting belts form a stable structure at the back of the pet under the action of the adjusting buckle and the inserting buckle; the whole connecting belts are tightly attached to the back body of the pet; and the tightness of each connecting belt can be conveniently adjusted.

### TECHNICAL FIELD

The present application relates to a foot protection device for a pet with freely adjustable tightness.

### BACKGROUND

Keeping dog pets has become a hobby of more people nowadays. In order to better protect the feet of pet dogs, pet shoes for a pet appear on the market. Pet shoes are prone to different degrees of dislocation during wearing and walking. In serious cases, they cause bad standing posture of pets and sprain key parts of pets' ankles. In addition, the shedding and loss of pet shoes often occur, resulting in economic losses. Therefore, people design to combine the pet shoes and the connecting belt into a whole, and the other end of the connecting belt is connected together through a pressing buckle, so that the pet shoes can be stably worn on the pet's feet through the action of the connecting belt, thus playing a protective role; However, only by pressing a button, it is difficult for the four connecting belts to keep a high fit with the pet's body, and it is still difficult to reach a very stable state. Moreover, the adjustment of the tightness of a single connecting belt is inconvenient, and the pet's wearing comfort is poor, which needs further improvement.

### SUMMARY

In view of the shortcomings of the above problems, the present application provides a foot protection device for a pet with freely adjustable tightness.

In order to achieve the above purpose, the present application provides a foot protection device for a pet with freely adjustable tightness, which includes a foot wrap for a pet to wear, connecting belts connected with the foot wrap, an adjusting buckle, an inserting buckle and a plurality of pressing buckles, wherein the adjusting buckle is flat as a whole; a first hole and a second hole for passing through are provided on the adjusting buckle, and the inserting buckle is divided into a plug connector and a plug box which are mutually inserted; the plug connector is provided with a first through hole for passing through, and the plug box is provided with a second hole for passing through; when the device is worn by the pet, the connecting belt at the front passes through the first through hole and is locked by the pressing buckle, while the connecting belt at the back passes through the second hole, the first hole and the second through hole in turn and is locked by the pressing buckle.

The foot protection device for a pet is convenient to wear, and the foot wrap is connected with the connecting belts. The foot wrap is not easy to fall off and is comfortable to wear, and do not shift, thus effectively correcting the standing posture of the pet and protecting the ankles of pets. The free ends of the connecting belts form a stable structure at the back of the pet by the functions of adjusting buckles and inserting buckles; the whole connecting belt is tightly attached to the back body of the pet, so that the pet is comfortable to wear; and the tightness of each connecting belt can be conveniently adjusted without mutual influence. It is suitable for pets with long or short feet or disabilities, and has better versatility.

As a further improvement of the solution, the foot wrap and the connecting belts are detachably connected by a zipper.

In the technical solution, the foot wrap and the connecting belts form a detachable structure by a zipper, and the foot wrap and the connecting belts can be used independently or in combination to meet more actual scenes.

As a further improvement of the solution, the connecting belt is slender as a whole, and the connecting belts form a fully enclosed cylinder at the position connected with the foot wrap, and the cylinder can wrap the trunk between the ankle and the joint of the pet.

In the technical solution, by the cylinder design of the connecting belts, the connecting belts is tightly attached to the calf of the pet, and the product is more beautiful and decent to wear.

As a further improvement of the solution, the device also includes a tightening belt, which is equipped with a pressing buckle to tighten the tightening belt outside the cylinder.

In the technical solution, the tightening belt makes the cylinder basically fit with the little leg of the pet, which makes it more beautiful to wear.

As a further improvement of the solution, both the first hole and the second hole are in the shape of an annular runway, and there are two second holes, and the two second holes separate the connecting belts at the back from each other.

In the technical solution, the two second holes are arranged to separate the connecting belts at the back, which is convenient for the independent adjustment of the tightness of the connecting belts at the back.

As a further improvement of the solution, there are two first through holes, which are arc-shaped, and the two first through holes separate the connecting belts at the front from each other.

In the technical solution, the two first through holes are arranged to separate the connecting belt at the front, which is convenient for the independent adjustment of the tightness of the front connecting belt.

Compared with the prior art, the present application has the beneficial effects that the foot protection device for the pet is convenient to wear, the foot wrap is connected with the connecting belts and is not easy to fall off. The foot wrap is comfortable to wear and does not shift, the standing posture of the pet is effectively corrected, and the ankle part of the pet is protected. The free ends of the connecting belts form a stable structure at the back of the pet by the function of adjusting buckles and inserting buckles, and the whole connecting belt is tightly attached to the back body of the pet, so that the pet is comfortable to wear, and each connecting belt can be convenient. The foot wrap and the connecting belt form a detachable structure by a zipper, and the foot wrap and the connecting belt can be used alone or in combination to meet more actual scenes.

### BRIEF DESCRIPTION OF DRAWINGS

FIG. 1 is a perspective view of a foot protection device for a pet with freely adjustable tightness;

FIG. 2 is a plan view of a foot protection device for a pet with freely adjustable tightness;

FIG. 3 is an enlarged view of position Ain FIG. 1;

FIG. 4 is an enlarged view of position in FIG. 2;

FIG. 5 is a schematic diagram of the buckle;

FIG. 6 is a schematic diagram of the adjusting buckle;

FIG. 7 is a schematic diagram of the pressing buckle.

In the figures: 1. Foot wrap; 2. Connecting belt; 21. Cylinder; 3. Fastening belt; 4. Pressing buckle; 5. Adjusting buckle; 51. First hole; 52. Second hole; 6, Inserting buckle; 61. Plug connector; 61. First through hole; 62. Plug box; 61. Second through hole.

### DESCRIPTION OF EMBODIMENTS

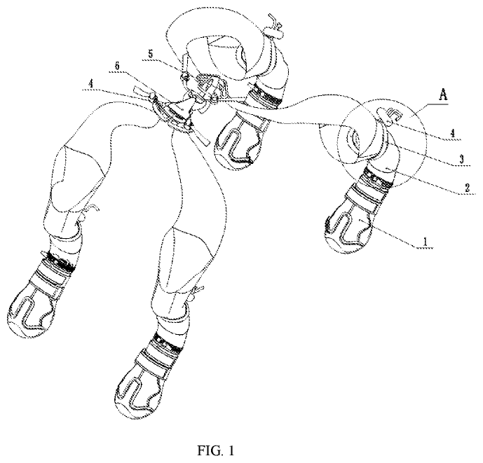

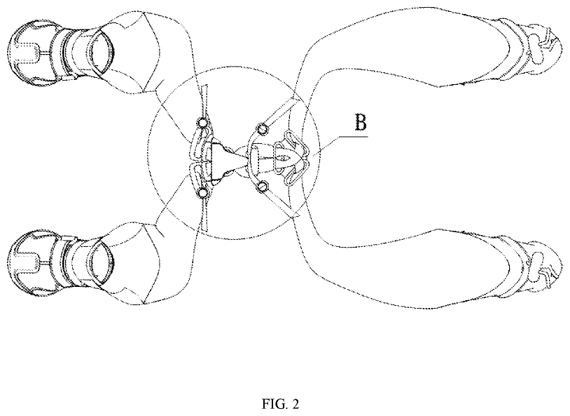

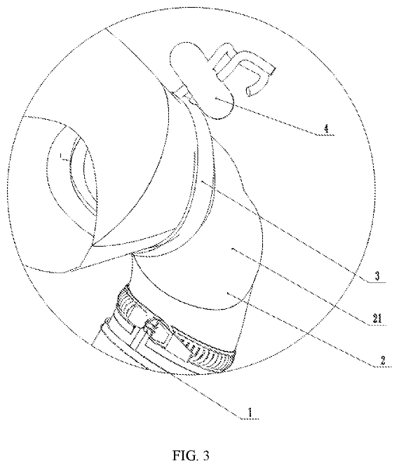

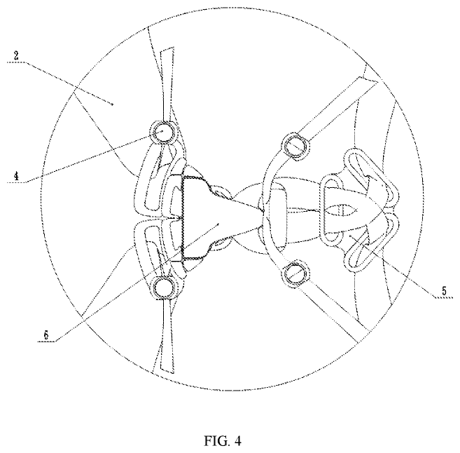

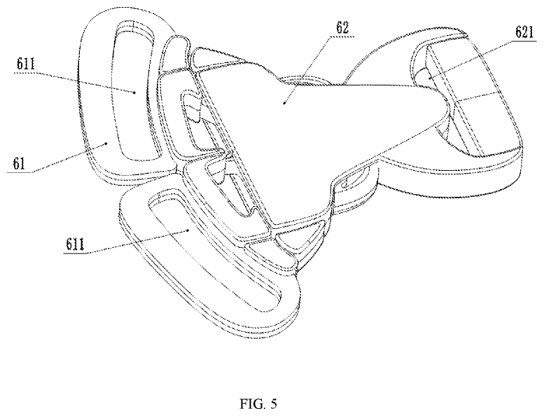

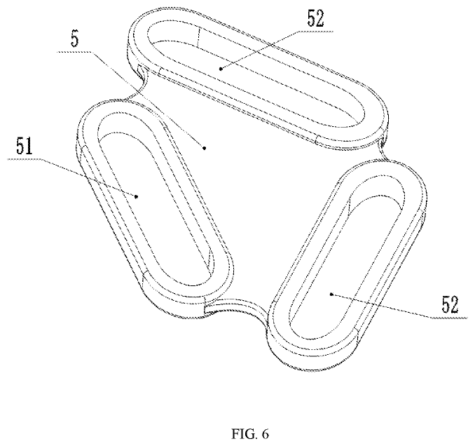

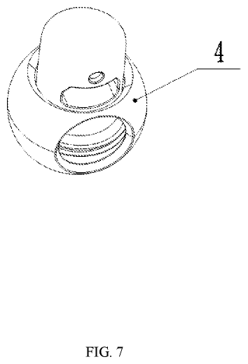

Example 1: as shown in FIGS. 1 to 7, a foot protection device for a pet with freely adjustable tightness according to the embodiment of the present application includes a foot warp 1 for a pet to wear, a connecting belt 2 connected with the foot wrap 1, an adjusting buckle 5, an inserting buckle 6 and a plurality of pressing buckles 4, wherein the adjusting buckle 5 is flat as a whole, and the adjusting buckle 5 is provided with a first hole 51 and a second hole 52 for passing through, and the inserting buckle 6 is divided into a plug connector 61 and a plug box 62 which are mutually plugged; the plug connector 61 is provided with a first through hole 611 for passing through, and the plug box 62 is provided with a second hole 621 for passing through; when the device is worn by the pet, the connecting belt 2 at the front passes through the first through hole 611 and is locked by the pressing buckle 4, while the connecting belt 2 at the back passes through the second hole 52, the first hole 51 and the second through hole 621 in turn and is locked by the pressing buckle 4; wherein the foot wrap 1 and the connecting belt 2 are detachably connected by zipper, The foot wrap and the connecting belts can be used alone or in combination to meet more actual scenes. The whole connecting belt 2 is slender, and the connecting belts 2 form a fully enclosed cylinder 21 at the position connected with the foot wrap 1. The cylinder 21 can wrap the trunk between the ankle and the joints of the pet. Through the cylinder design of the connecting belt, the connecting belt is tightly attached to the calf of the pet, and the product is more beautiful and decent to wear. The foot protection device for a pet further incudes a tightening belt 3, which is provided with a pressing buckle 4, and the pressing buckle 4 makes the tightening belt 3 tightly tied to the outside of the cylinder 21, and the tightening belt makes the cylinder basically fit with the little legs of pets, so that it is more beautiful to wear. The first hole 51 and the second hole 52 are all in the shape of an annular racetrack, and there are two second holes 52. The two second holes 52 separate the rear connecting belts 2 from each other, and the two second holes are arranged to separate the rear connecting belts, so that the tightness of the rear connecting belts can be adjusted independently. There are two first through holes 611, which are arc-shaped. The two first through holes 611 separate the front connecting belts 2 from each other, and the two first through holes are arranged to separate the front connecting belts, so that the tightness of the front connecting belts can be adjusted independently.

Example 2: The structure is the same as that of Example 1, except that the adjusting buckle 5 is not provided in Example 2.

The foot protection device for a pet is convenient to wear, the foot wrap is connected with the connecting belts, and the foot wrap is not easy to fall off. The foot wrap is comfortable to wear, and does not shift, thus effectively correcting the standing posture of pets and protecting the ankles of pets; the free end of the connecting belt forms a stable structure at the back of pets by the functions of adjusting buckles and inserting buckles; the whole connecting belt is tightly attached to the back body of pets, so that pets are comfortable to wear; and the tightness of each connecting belt can be conveniently adjusted without mutual influence. The foot wrap and the connecting belts form a detachable structure by zipper, and the foot wrap and the connecting belt can be used alone or in combination to meet more actual scenes.

The above is only the preferred embodiment of the present application, and it is not intended to limit the present application. For those skilled in the art, the present application can be modified and changed. Any modification, equivalent substitution, improvement, etc. made within the spirit and principle of the present application shall be included in the scope of protection of the present application.

What is claimed is:

1. A foot protection device for a pet with freely adjustable tightness, comprising a foot wrap for the pet to wear, a connecting belt connected with the foot wrap, an adjusting buckle, an inserting buckle and a plurality of pressing buckles, wherein the adjusting buckle is flat as a whole; a first hole and a second hole for passing through are provided on the adjusting buckle; the inserting buckle is divided into a plug connector and a plug box which are mutually plugged; the plug connector is provided with a first through hole for passing through, and the plug box is provided with a second hole for passing through;
when the device is worn by the pet, the connecting belt at the front passes through the first through hole and is locked by the pressing buckle, while the connecting belt at the back passes through the second hole, the first hole and the second through hole in turn and is locked by the pressing buckle.

2. The foot protection device for a pet with freely adjustable tightness according to claim 1, wherein the foot wrap and the connecting belts are detachably connected by a zipper.

3. The foot protection device for a pet with freely adjustable tightness according to claim 2, wherein the whole connecting belts are slender, and the connecting belts form a fully enclosed cylinder at the position connected with the foot wrap, and the cylinder can wrap the trunk between the ankle and the joint of the pet.

4. The foot protection device for a pet with freely adjustable tightness according to claim 3, further comprising a tightening belt, wherein the tightening belt is provided with a pressing buckle which makes the tightening belt tightly tied outside the cylinder.

5. The foot protection device for a pet with freely adjustable tightness according to claim 1, wherein the first hole and the second hole are both in the shape of an annular racetrack, and there are two second holes, and the two second holes separate the connecting belts at the back from each other.

6. The foot protection device for a pet with freely adjustable tightness according to claim 1, wherein there are two first through holes which are arc-shaped, and the two first through holes separate the connecting belts at the front from each other.

7. A foot protection device for a pet with freely adjustable tightness, comprising a foot wrap for the pet to wear, connecting belts connected with the foot wrap, an inserting buckle and a plurality of pressing buckles, wherein the inserting buckle is divided into a plug connector and a plug box which are mutually inserted; the plug connector is provided with a first through hole for passing through, and the plug box is provided with a second hole for passing through;
when the device is worn by the pet, the connecting belt at the front passes through the first through hole and is locked by the pressing buckle, while the connecting belt at the back passes through the second through hole and is locked by the pressing buckle.

8. The foot protection device for a pet with freely adjustable tightness according to claim 7, wherein the foot wrap and the connecting belts are detachably connected by a zipper.

9. The foot protection device for a pet with freely adjustable tightness according to claim 8, wherein the whole connecting belts are slender, and the connecting belts form a fully enclosed cylinder at the position connected with the foot wrap, and the cylinder can wrap the trunk between the ankle and the joint of the pet.

10. The foot protection device for a pet with freely adjustable tightness according to claim 9, further comprising a tightening belt, wherein the tightening belt is provided with a pressing buckle which makes the tightening belt tightly tied outside the cylinder.
